(19) United States
(12) Patent Application Publication
(10) Pub. No.: US 2005/0025098 A1
(43) Pub. Date: Feb. 3, 2005

(54) Communication system, transmitter of the system, receiver of the system, and physical layer control method

(76) Inventor: Shigeo Terabe, Hino-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/801,548

(22) Filed: Mar. 17, 2004

(30) Foreign Application Priority Data
Jul. 18, 2003 (JP) 2003-199295

(51) Int. Cl. H04Q 7/00

(52) U.S. Cl. 370/332

(57) ABSTRACT

Communication system which executes data communication of parallel combinatory spread spectrum scheme between transmitter and receiver, transmitter comprising acquiring unit which acquires radio channel quality information by measuring radio channel quality when transmitter receives signal, information generation unit which generates first physical layer control information for control of physical layer based on radio channel quality information at first control timing which fails to be in cooperation with dedicated channel for control of physical layer, and first transmission unit which transmits, to receiver, first physical layer control information by selected spreading-code data of parallel combinatory spread spectrum scheme, and receiver comprising first receiving unit which receives first physical layer control information by selected spreading-code data of parallel combinatory spread spectrum scheme, and physical layer control unit controls physical layer between receiver and transmitter based on first physical layer control information.

### CROSS-REFERENCE TO RELATED APPLICATIONS

This application is based upon and claims the benefit of priority from prior Japanese Patent Application No. 2003-199295, filed Jul. 18, 2003, the entire contents of which are incorporated herein by reference.

### BACKGROUND OF THE INVENTION

1. Field of the Invention

The present invention relates to a communication system and, more particularly, to a communication system which executes physical layer control by using spreading codes of a parallel combinatory spread spectrum scheme, a transmitter of the system, a receiver of the system, and a physical layer control method.

2. Description of the Related Art

A spread spectrum communication apparatus and spread spectrum communication method are known in association with data communication of a mobile communication system (e.g., Jpn. Pat. Appln. KOKAI Publication No. 9-205412 (p. 4, FIGS. 1 and 2)).

In the spread spectrum communication method described in patent reference 1, primary communication data to be subjected to modulation and spread processing and secondary communication data which adds a code to a combination of a plurality of spreading codes are prepared.

For this conventional apparatus, however, there is no description of any detailed technique about how to use the secondary communication data which adds a code to a combination of a plurality of spreading codes.

### BRIEF SUMMARY OF THE INVENTION

It is an object of the present invention to provide a communication system using a spread spectrum communication method which exploits the high communication speed of secondary communication data and the application purpose of sub-communication information, a transmitter of the system, a receiver of the system, and a physical layer control method.

According to a first aspect of the invention, there is provided a communication system which executes data communication of a parallel combinatory spread spectrum scheme between a transmitter and a receiver, the transmitter comprising: an acquiring unit configured to acquire radio channel quality information by measuring a radio channel quality when the transmitter receives a signal; an information generation unit configured to generate first physical layer control information for control of a physical layer based on the radio channel quality information at a first control timing which fails to be in cooperation with a dedicated channel for the control of the physical layer; and a first transmission unit configured to transmit, to the receiver, the first physical layer control information by selected spreading-code data of the parallel combinatory spread spectrum scheme, and the receiver comprising: a first receiving unit configured to receive the first physical layer control information by the selected spreading-code data of the parallel combinatory spread spectrum scheme; and a physical layer control unit configured to control the physical layer between the receiver and the transmitter based on the first physical layer control information.

According to a second aspect of the invention, there is provided a transmitter comprising: an acquiring unit configured to acquire radio channel quality information by measuring a radio channel quality when the transmitter receives a signal; an information generation unit configured to generate first physical layer control information for control of a physical layer based on the radio channel quality information at a first control timing which fails to be in cooperation with a dedicated channel for the control of the physical layer; and a first transmission unit configured to transmit, to the receiver, the first physical layer control information by selected spreading-code data of a parallel combinatory spread spectrum scheme.

According to a third aspect of the invention, there is provided a receiver comprising: a first receiving unit configured to receive first physical layer control information for control of a physical layer by selected spreading-code data of a parallel combinatory spread spectrum scheme; and a physical layer control unit configured to control the physical layer between the receiver and a transmitter based on the first physical layer control information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing mapping of spreading codes used in a parallel combinatory spread spectrum scheme according to the embodiment;

FIG. 2 is a block diagram of the main part of a mobile station in a mobile communication system according to the embodiment;

FIG. 3 is a block diagram of the main part of a base station in the mobile communication system according to the embodiment;

FIG. 4 is a timing chart of downlink transmission data rate control according to the embodiment;

FIG. 5 is a flow chart showing the operation of the mobile station in the mobile communication system according to the embodiment;

FIG. 6 is a flow chart showing the operation of the base station in the mobile communication system according to the embodiment; and

FIG. 7 is a timing chart of downlink transmission data rate control.

### DETAILED DESCRIPTION OF THE INVENTION

The embodiment of the present invention implements, in a communication system contained between a transmitter and a receiver, physical layer control which uses both a dedicated channel and a parallel combinatory spread spectrum scheme.

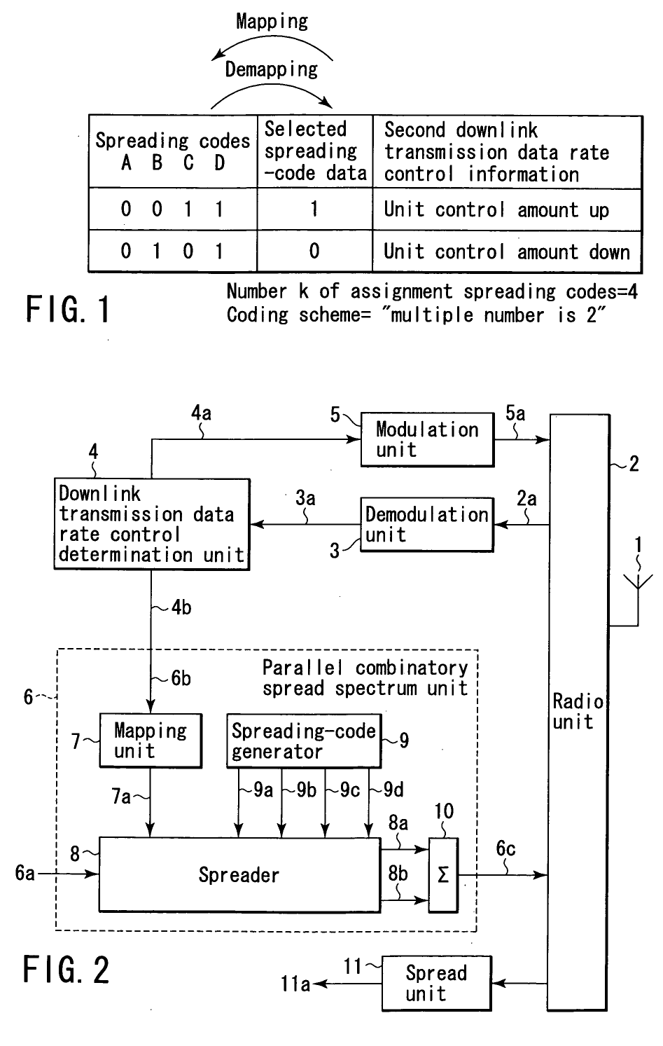

FIGS. 1 to 7 show an embodiment of a base station (i.e., a receiver) and a mobile station (i.e., a transmitter) in a communication system according to the embodiment.

The parallel combinatory spread spectrum scheme will be described first with reference to FIGS. 1 to 3. FIG. 1 is a view showing the use combination states of spreading codes used in the parallel combinatory spread spectrum scheme. In the example shown in FIG. 1, a number k of assignment spreading codes is “4”, i.e., k (=4) spreading codes A, B, C, and D are used, and the multiple number is “2”. The multiple number indicates the number of spreading codes which are used simultaneously.

More specifically, in the field “spreading codes” shown in FIG. 1, “1” is assigned to each of two spreading codes which are simultaneously used in the k spreading codes A, B, C, and D. For example, when the spreading codes C and D are simultaneously used, the pattern is “0011”, and 1-bit selected spreading-code data is “1”. When the spreading codes B and D are simultaneously used, the pattern is “0101”, and 1-bit selected spreading-code data is “0”.

The transmitter changes 1-bit selected spreading-code data into a pattern of k spreading codes. This is called “mapping”. On the other hand, the receiver detects spreading codes which are simultaneously used and reproduces 1-bit selected spreading-code data from k spreading codes. This is called “demapping”.

In the parallel combinatory spread spectrum scheme, two types of data, i.e., spread sequence data and selected spreading-code data can be transmitted from the transmitter to the receiver.

For example, in the transmitter, when selected spreading-code data is “1”, it is mapped onto the pattern “0011” in which the spreading codes C and D are simultaneously used. When selected spreading-code data is “0”, it is mapped onto the pattern “0101” in which the spreading codes B and D are simultaneously used. Selected spreading-code data is transmission data which are divided into two sequences (the C-sequence and D-sequence, or the B-sequence and D-sequence). When selected spreading-code data is “1”, the data of the C-sequence and D-sequence are multiplied by the spreading codes C and D. A spread signal is generated by adding the products and transmitted. When selected spreading-code data is “0”, the data of the B-sequence and D-sequence are multiplied by the spreading codes B and D. A spread signal is generated by adding the products and transmitted.

On the other hand, in the receiver, when the spread signal from the transmitter is received, the spread signal is multiplied by each of the k (=4) spreading codes A, B, C, and D to execute despread. When the spreading codes C and D are used in the transmitter, the energy levels of the despread results of the spreading codes C and D appear high. By using the spreading codes C and D whose energy levels appear high, the spread sequence data is reproduced. The pattern of the combinatory spreading codes of the spreading codes C and D whose energy levels appear high is “0011”. When this pattern is demapped on the basis of the table shown in FIG. 1, the selected spreading-code data “1” is reproduced. Even when the energy levels of the despread results of the spreading codes B and D appear high upon despread processing, its pattern is demapped, and the selected spreading-code data “0” is reproduced.

FIG. 2 is a block diagram of the main part of the mobile station. The mobile station contains an antenna 1, radio unit 2, demodulation unit 3, downlink transmission data rate control determination unit 4 (information generation unit), modulation unit 5, and parallel combinatory spread spectrum unit 6. The radio unit 2 is connected to the antenna 1, demodulation unit 3, modulation unit 5, and parallel combinatory spread spectrum unit 6. The demodulation unit 3 is connected to the downlink transmission data rate control determination unit 4. The downlink transmission data rate control determination unit 4 is connected to the modulation unit 5 and parallel combinatory spread spectrum unit 6.

The parallel combinatory spread spectrum unit 6 receives spread sequence data input in the mobile station, generates transmission data by the parallel combinatory spread spectrum scheme, and transmits the data to the base station through the radio unit 2 and antenna 1. The parallel combinatory spread spectrum unit 6 contains a mapping unit 7, spreader 8, spreading-code generator 9, and adder 10.

Second downlink transmission data rate control information 4b sent from the downlink transmission data rate control determination unit 4 is supplied to the mapping unit 7 of the parallel combinatory spread spectrum unit 6 as selected spreading-code data 6b. The mapping unit 7 stores the contents of the table shown in FIG. 1. Hence, the mapping unit 7 maps the selected spreading-code data onto a pattern of the k (=4) spreading codes A, B, C, and D on the basis of the contents of the selected spreading-code data 6b and sends mapping data 7a to the spreader 8. The spreading-code generator 9 sends, to the spreader 8, a signal 9a of the spreading code A, a signal 9b of the spreading code B, a signal 9c of the spreading code C, and a signal 9d of the spreading code D in correspondence with the k spreading codes.

The spreader 8 multiplies spread sequence data 6a by two spreading codes (e.g., the spreading codes C and D) selected by the mapping data 7a to spread the data and sends product outputs 8a and 8b of two sequences to the adder 10. The adder 10 adds the product outputs 8a and 8b of two sequences and sends a sum output 6c to the radio unit 2. The radio unit 2 executes processing such as up-conversion. The spread signal is transmitted from the antenna 1 to the mobile station.

The arrangement and operation of the base station which receives the spread signal will be described next.

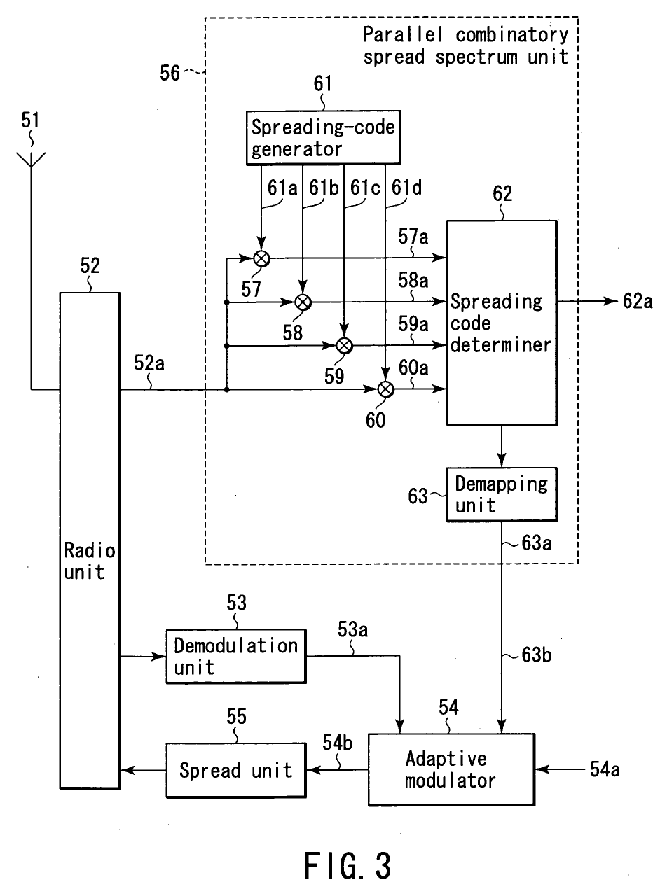

FIG. 3 is a block diagram of the main part of the base station. The base station contains an antenna 51, radio unit 52, demodulation unit 53, adaptive modulator 54, spread unit 55, and parallel combinatory spread spectrum unit 56. The radio unit 52 is connected to the antenna 51, demodulation unit 53, spread unit 55, and parallel combinatory spread spectrum unit 56. The demodulation unit 53 is connected to the adaptive modulator 54. The adaptive modulator 54 is connected to the spread unit 55 and parallel combinatory spread spectrum unit 56.

By using the parallel combinatory spread spectrum scheme, the parallel combinatory spread spectrum unit 56 generates spread sequence data from the spread signal received through the antenna 51 and radio unit 52. The parallel combinatory spread spectrum unit 56 contains multipliers 57, 58, 59, and 60, a spreading-code generator 61, spreading code determiner 62, and demapping unit 63. The demapping unit 63 obtains a demapping signal, although it stores the contents of the table shown in FIG. 1, like the mapping unit 7 of the mobile station.

In the base station having the above arrangement, the spread signal transmitted from the mobile station is received by the radio unit 52 through the antenna 51. The radio unit 52 executes processing such as down-conversion and sends an output signal 52a to the multipliers 57, 58, 59, and 60 of the parallel combinatory spread spectrum unit 56. The spreading-code generator 61 of the parallel combinatory spread spectrum unit 56 generates a signal 61a of the spreading code A, a signal 61b of the spreading code B, a signal 61c of the spreading code C, and a signal 61d of the spreading code D in correspondence with the k (=4) spreading codes and sends each signal to a corresponding one of the multipliers 57, 58, 59, and 60.

Each of the multipliers 57, 58, 59, and 60 multiplies the signal 52a by a corresponding one of the spreading codes A, B, C, and D to execute despread processing. Signals 57a, 58a, 59a, and 60a are sent to the spreading code determiner 62.

The spreading code determiner 62 checks the energy levels of the signals 57a, 58a, 59a, and 60a. For example, when the multiple number is “2”, the energy levels of the multipliers 59 and 60 (or 58 and 60) corresponding to two spreading codes (the spreading codes C and D or B and D) appear high. The spreading code determiner 62 compares the energy levels of the output signals 57a, 58a, 59a, and 60a from the multipliers 57, 58, 59, and 60 and determines the two spreading codes used on the mobile station side.

The spreading code determiner 62 despreads the outputs from the multipliers corresponding to the two determined spreading codes to reproduce spread sequence data 62a.

The two determined spreading codes are sent from the spreading code determiner 62 to the demapping unit 63. The demapping unit 63 determines the spreading code combination from the two spreading codes and executes demapping on the basis of the table shown in FIG. 1 to reproduce selected spreading-code data 63a.

Downlink transmission data rate control as one of physical layer control operations between the base station and the mobile station will be described next by using selected spreading-code data of the parallel combinatory spread spectrum scheme.

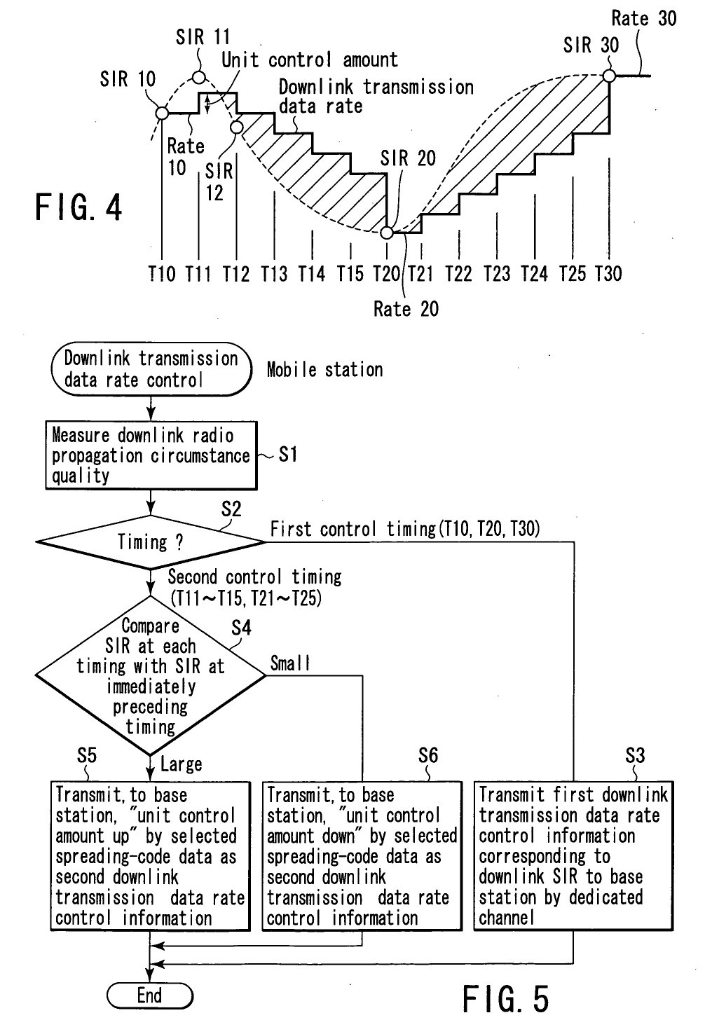

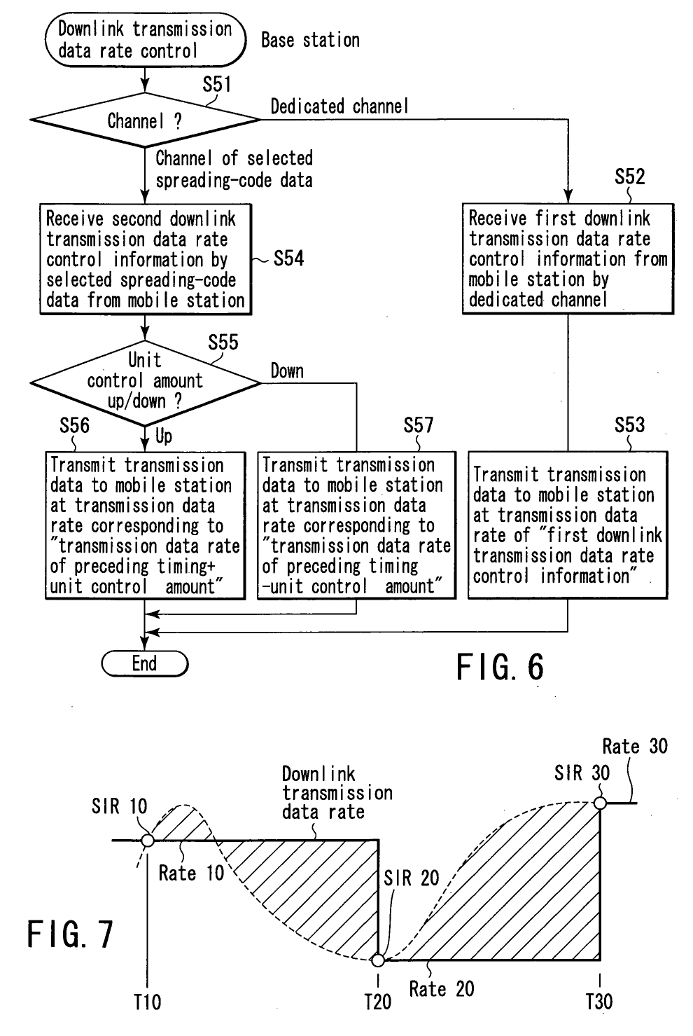

FIG. 4 is a timing chart showing downlink transmission data rate control. FIG. 5 is a flow chart of the downlink transmission data rate control of the mobile station. FIG. 6 is a flow chart of the downlink transmission data rate control of the base station. FIG. 7 is a timing chart showing downlink transmission data rate control.

A downlink SIR (Signal-to-Interference Ratio) 3a indicated by the dotted line in FIG. 4 is a measurement value representing the downlink radio propagation circumstance quality from the base station to the mobile station. The waveform normally varies. In correspondence with the variation, the downlink transmission data rate is controlled as indicated by the solid line.

As the downlink transmission data rate control, two types of control are executed in accordance with timings. One of downlink transmission data rate control by a dedicated channel for physical layer control, which corresponds to timings T10, T20, and T30 in FIG. 4. The other is downlink transmission data rate control by selected spreading-code data of the parallel combinatory spread spectrum scheme, which corresponds to timings T11, T12, T13, T14, T15, T21, T22, T23, T24, and T25 in the intervals between the timings T10, T20, and T30.

The downlink transmission data rate control in the mobile station shown in FIG. 4 will be described next with reference to FIG. 5.

The demodulation unit 3 of the mobile station calculates the downlink SIR 3a by measuring the reception power of a common pilot signal which is normally transmitted from the base station to the mobile station. More specifically, the common pilot signal from the base station is received by the radio unit 2 through the antenna 1. The radio unit 2 executes processing such as down-conversion for the received common pilot signal and sends a signal 2a to the demodulation unit 3. The demodulation unit 3 demodulates the received signal 2a. The demodulation unit 3 also calculates the downlink SIR 3a by measuring the reception power of the common pilot signal and sends the downlink SIR 3a to the downlink transmission data rate control determination unit 4 (step S1).

The downlink transmission data rate control determination unit 4 confirms the slot timing shown in the timing chart in FIG. 4 (step S2). At the first control timing (T10, T20, or T30), the downlink transmission data rate control determination unit 4 sets the downlink transmission data rate directly corresponding to the downlink SIR 3a to first downlink transmission data rate control information 4a (step S3). More specifically, at the timing T10, rate 10 is set as the first downlink transmission data rate control information 4a corresponding to SIR 10. At the timing T20, rate 20 is set as the first downlink transmission data rate control information 4a corresponding to SIR 20. At the timing T30, rate 30 is set as the first downlink transmission data rate control information 4a corresponding to SIR 30.

The first downlink transmission data rate control information 4a generated by the downlink transmission data rate control determination unit 4 is sent to the modulation unit 5 serving as a dedicated channel for physical layer control. The modulation unit 5 executes modulation processing and sends a modulated signal 5a to the radio unit 2. Upon receiving the modulated signal 5a, the radio unit 2 executes processing such as up-conversion and transmits the signal from the antenna 1 to the base station.

In step S2, at the second control timing (T11, T12, T13, T14, T15, T21, T22, T23, T24, or T25), the downlink transmission data rate control determination unit 4 compares the downlink SIR 3a at each timing with the downlink SIR 3a at the immediately preceding timing (step S4). If the downlink SIR 3a at each timing is larger than that at the immediately preceding timing, the downlink transmission data rate control determination unit 4 sends, to the parallel combinatory spread spectrum unit 6 as the second downlink transmission data rate control information 4b, “unit control amount up” which increases the downlink transmission data rate by a unit control amount. For example, the downlink SIR 3a (SIR 11) at the timing T11 is larger than the downlink SIR 3a (SIR 10) at the immediately preceding timing T10. Hence, a downlink transmission data rate increased by the unit control amount is set. For the downlink SIRs 3a shown in FIG. 4, the “unit control amount up” is executed at the timings T11, T21, T22, T23, T24, and T25.

The second downlink transmission data rate control information 4b is sent to the mapping unit 7 of the parallel combinatory spread spectrum unit 6 as the selected spreading-code data 6b. The mapping unit 7 maps the selected spreading-code data on the basis of the combination of spreading codes in the table shown in FIG. 1. The signal 6c spread by the parallel combinatory spread spectrum unit 6 is radio-processed by the radio unit 2 and transmitted from the antenna 1 to the base station (step S5).

If it is determined in step S4 that the downlink SIR 3a at each timing is smaller than that at the immediately preceding timing, the downlink transmission data rate control determination unit 4 sends, to the parallel combinatory spread spectrum unit 6 as the second downlink transmission data rate control information 4b, “unit control amount down” which decreases the downlink transmission data rate by the unit control amount. For example, the downlink SIR 3a (SIR 12) at the timing T12 is smaller than the downlink SIR 3a (SIR 11) at the immediately preceding timing T11. Hence, a downlink transmission data rate decreased by the unit control amount is set. For the downlink SIRs 3a shown in FIG. 4, the “unit control amount down” is executed at the timings T12 to T15. The signal 6c spread by the parallel combinatory spread spectrum unit 6 is radio-processed by the radio unit 2 and transmitted from the antenna 1 to the base station (step S6).

The downlink transmission data rate control in the base station shown in FIG. 3, which has received the first and second downlink transmission data rate control information, will be described next with reference to the flow chart in FIG. 6.

In base station, the first downlink transmission data rate control information 4a is received by the radio unit 52 through the antenna 51, subjected to processing such as down-conversion, and sent to the demodulation unit 53 serving as a dedicated channel for physical layer control. The demodulation unit 53 executes demodulation to reproduce the first downlink transmission data rate control information 4a and sends it to the adaptive modulator 54 as first downlink transmission data rate control information 53a.

When the second downlink transmission data rate control information 4b is received by the radio unit 52 through the antenna 51, the parallel combinatory spread spectrum unit 56 executes despread processing to reproduce the selected spreading-code data 63a. In addition, the second downlink transmission data rate control information 4b is reproduced and sent to the adaptive modulator 54 as second downlink transmission data rate control information 63b.

Transmission data 54a to the mobile station, which is input to the adaptive modulator 54, is subjected to adaptive modulation control (physical layer control). The adaptive modulator 54 executes processing in accordance with the radio channel quality. More specifically, when the radio channel quality is high, the adaptive modulator 54 sets the transmission data 54a to a high rate. When the radio channel quality is poor, the adaptive modulator 54 sets the transmission data 54a to a low rate.

The adaptive modulator 54 checks the incoming call situation of the channel (step S51). When an incoming call from the demodulation unit 53 serving as a dedicated channel is detected, the first downlink transmission data rate control information 53a is received (step S52). The adaptive modulator 54 sends the transmission data 54a to the spread unit 55 at the designated rate of the first downlink transmission data rate control information 53a (step S53). The spread unit 55 spreads a signal 54b and transmits it to the radio unit 52. The radio unit 52 executes processing such as up-conversion and transmits the signal from the antenna 51 to the mobile station. The timings T10, T20, and T30 correspond to this processing. The arrangement and operation of the spread unit 55 are the same as those of the parallel combinatory spread spectrum unit 6 shown in FIG. 2, and a description thereof will be omitted.

On the other hand, when arrival of the selected spreading-code data 63a is detected in step S51, the adaptive modulator 54 receives the second downlink transmission data rate control information 63b (step S54). The adaptive modulator 54 determines whether the second downlink transmission data rate control information 63b should be subjected to “unit control amount up” or “unit control amount down” (step S55).

For “unit control amount up”, the adaptive modulator 54 sends the transmission data 54a to the spread unit 55 at a rate obtained by increasing the transmission data rate at the immediately preceding timing by the unit control amount (step S56). The spread unit 55 executes spread processing. In addition, the radio unit 52 executes up-conversion processing. The data is transmitted from the antenna 51 to the mobile station. The timings T11, T21, T22, T23, T24, and T25 correspond to this processing.

If it is determined in step S55 that “unit control amount down” should be executed, the adaptive modulator 54 sends the transmission data 54a to the spread unit 55 at a rate obtained by decreasing the transmission data rate at the immediately preceding timing by the unit control amount (step S57). The spread unit 55 executes spread processing. In addition, the radio unit 52 executes up-conversion processing. The data is transmitted from the antenna 51 to the mobile station as an adaptive modulated signal. The timings T12, T13, T14, and T15 correspond to this processing.

The operation in the mobile station which has received the adaptive modulated signal will be described next. In the mobile station, the adaptive modulated signal from the base station is received by the radio unit 2 through the antenna 1, subjected to processing such as down-conversion, and sent to a spread unit 11. The spread unit 11 executes despread processing to obtain reception data 11a so that the transmission data 54a transmitted from the base station is reproduced.

The arrangement and operation of the spread unit 11 are the same as those of the parallel combinatory spread spectrum unit 56 shown in FIG. 3, and a description thereof will be omitted.

The mobile station repeatedly executes the operation shown in FIG. 5. The base station repeatedly executes the operation shown in FIG. 6. The downlink transmission data rate control shown in FIG. 4 is thus executed.

FIG. 7 is a timing chart showing downlink transmission data rate control when only the first downlink transmission data rate control information 4a as the dedicated channel information of physical layer control is used.

Since control for the timings T10, T20, and T30 is executed, a downlink transmission data rate indicated by the solid line is obtained. The downlink radio propagation circumstances always vary as the mobile station moves. Accordingly, the downlink SIR 3a also always varies. For this reason, the hatched portion shown in FIG. 7 is the difference between the downlink SIR and the downlink transmission data rate. If this difference is large, the downlink transmission data rate is too high. A transmission error of the transmission data 54a transmitted from the base station to the mobile station may occur, or conversely, the downlink transmission data rate is suppressed low.

As compared to this, in downlink transmission data rate control which uses both the first downlink transmission data rate control information 4a as the dedicated channel information of physical layer control and the second downlink transmission data rate control information 4b as the selected spreading-code data of the parallel combinatory spread spectrum scheme shown in FIG. 4, the hatched portion representing the difference between the downlink SIR and the downlink transmission data rate can be made small. Hence, fine downlink transmission data rate control corresponding to the change in downlink radio propagation circumstances can be executed.

Even in a mobile communication system using only the first downlink transmission data rate control information 4a as the dedicated channel information of physical layer control, the base station or mobile station can maintain compatibility.

When the second downlink transmission data rate control information 4b as selected spreading-code data is used, the transmission data rate can directly be designed instead of designating unit control amount up/down. To do this, the downlink SIR is measured, and a transmission data rate corresponding to it is directly determined. In this case, the number of different transmission data rates is increased by increasing the combinations of spreading codes shown in FIG. 1 as transmission data rate information, and selected spreading-code data is mapped onto the transmission data rate information.

In the above-described embodiment, downlink transmission data rate control as one of physical layer control information has been described. However, the same control as described above can be executed even for transmission power control corresponding to a change in radio propagation circumstances. In uplink transmission power control, the base station transmits the uplink transmission power control information of physical layer control information by selected spreading-code data, and the mobile station receives this information. If uplink transmission power control is executed by using a dedicated channel to quickly cope with an abrupt change in radio propagation circumstances, an adverse effect on radio resources is generated. However, when selected spreading-code data is used, the adverse effect on radio resources can be prevented.

The embodiment is suitable not only for the mobile communication system but also for wireless LAN or any other communication system which executes data communication of the parallel combinatory spread spectrum scheme. The embodiment can be applied to a transmitter and receiver in a wireless LAN or any other communication system.

As described above, the parallel spread spectrum method fundamentally executes transmission of spread sequence data. When selected spreading-code data is used, no special channel need be used, and any influence on radio resources can be prevented. In addition, since high-speed processing is possible, the system can cope with an abrupt change in radio propagation circumstances.

Hence, when both the dedicated channel and the selected spreading-code data are used, fine physical layer control can be executed.

Additional advantages and modifications will readily occur to those skilled in the art. Therefore, the embodiment in its broader aspects is not limited to the specific details and representative embodiments shown and described herein. Accordingly, various modifications may be made without departing from the spirit or scope of the general inventive concept as defined by the appended claims and their equivalents.

1. A communication system which executes data communication of a parallel combinatory spread spectrum scheme between a transmitter and a receiver,
the transmitter comprising:
an acquiring unit configured to acquire radio channel quality information by measuring a radio channel quality when the transmitter receives a signal;
an information generation unit configured to generate first physical layer control information for control of a physical layer based on the radio channel quality information at a first control timing which fails to be in cooperation with a dedicated channel for the control of the physical layer; and
a first transmission unit configured to transmit, to the receiver, the first physical layer control information by selected spreading-code data of the parallel combinatory spread spectrum scheme, and
the receiver comprising:
a first receiving unit configured to receive the first physical layer control information by the selected spreading-code data of the parallel combinatory spread spectrum scheme; and
a physical layer control unit configured to control the physical layer between the receiver and the transmitter based on the first physical layer control information.

2. The system according to claim 1, wherein if the radio channel quality measured in generating the first physical layer control information is higher than radio channel quality at an immediately preceding timing, the information generation unit generates the first physical layer control information which increases the control of the physical layer by a unit control amount, and if the radio channel quality measured in generating the first physical layer control information is poorer than the radio channel quality at the immediately preceding timing, the information generation unit generates the first physical layer control information which decreases the control of the physical layer by the unit control amount.

3. The system according to claim 1, wherein the information generation unit generates the first physical layer control information in correspondence with the radio channel quality information.

4. The system according to claim 1, wherein the acquiring unit acquires, as the radio channel quality information, SIR (Signal-to-Interference Ratio) information which is obtained by measuring a receiving power of a common pilot signal transmitted from the receiver to the transmitter.

5. The system according to claim 1, wherein the physical layer control unit sets, based on the first physical layer control information, a transmission data rate of data to be transmitted to the transmitter.

6. The system according to claim 5, wherein the receiver further comprises a transmission unit configured to transmit, to the transmitter, the data which is set to the transmission data rate and spread by a spread spectrum scheme.

7. The system according to claim 1, wherein
the transmitter further comprises a second transmission unit configured to transmit, to the receiver, second physical layer control information for the control of the physical layer over the dedicated channel,
the information generation unit generates the second physical layer control information based on the radio channel quality information at a second control timing which is in cooperation with the dedicated channel and generates the first physical layer control information based on the radio channel quality information at the first control timing which fails to be in cooperation with the dedicated channel,
the receiver further comprises a second receiving unit configured to receive the first physical layer control information over the dedicated channel, and
the physical layer control unit controls the physical layer between the receiver and the transmitter based on the first physical layer control information and the second physical layer control information.

8. The system according to claim 7, wherein the information generation unit generates the second physical layer control information in correspondence with the radio channel quality information.

9. The system according to claim 7, wherein the physical layer control unit sets, based on the first physical layer control information and the second physical layer control information, a transmission data rate of data to be transmitted to the transmitter.

10. A transmitter comprising:
an acquiring unit configured to acquire radio channel quality information by measuring a radio channel quality when the transmitter receives a signal;
an information generation unit configured to generate first physical layer control information for control of a physical layer based on the radio channel quality information at a first control timing which fails to be in cooperation with a dedicated channel for the control of the physical layer; and
a first transmission unit configured to transmit, to the receiver, the first physical layer control information by selected spreading-code data of a parallel combinatory spread spectrum scheme.

11. The transmitter according to claim 10, which further comprises a second transmission unit configured to transmit, to the receiver, second physical layer control information for the control of the physical layer over the dedicated channel of physical layer control,
wherein the information generation unit generates the second physical layer control information based on the radio channel quality information at a second control timing which is in cooperation with the dedicated channel and generates the first physical layer control information based on the radio channel quality information at the first control timing which fails to be in cooperation with the dedicated channel.

12. A receiver comprising:
a first receiving unit configured to receive first physical layer control information for control of a physical layer by selected spreading-code data of a parallel combinatory spread spectrum scheme; and
a physical layer control unit configured to control the physical layer between the receiver and a transmitter based on the first physical layer control information.

13. The receiver according to claim 12, which further comprises a second receiving unit configured to receive second physical layer control information for the control of the physical layer over a dedicated channel,
wherein the physical layer control unit controls the physical layer between the receiver and the transmitter based on the first physical layer control information and the second physical layer control information.

14. The receiver according to claim 13, wherein the physical layer control unit sets, based on the first physical layer control information and the second physical layer control information, a transmission data rate of data to be transmitted to the transmitter.
